(19) United States
(12) Patent Application Publication
(10) Pub. No.: US 2006/0246802 A1
(43) Pub. Date: Nov. 2, 2006

(54) Color change laminate material

(76) Inventors: Janis Wilson Hughes, Alpharetta, GA (US); Bryon Paul Day, Canton, GA (US); James Russell Fitts JR., Gainesville, GA (US); Ann Louise McCormack, Cumming, GA (US); Wing-Chak Ng, Suwanee, GA (US); Varunesh Sharma, Atlanta, GA (US)

Correspondence Address: KIMBERLY-CLARK WORLDWIDE, INC., 401 NORTH LAKE STREET, NEENAH, WI, 54956, US

(21) Appl. No.: 11/118,956

(22) Filed: Apr. 29, 2005

(51) Int. Cl. B32B 5/26; D03D 15/08; D04B 21/14; D04H 13/00; D03D 17/00; D04B 1/18

(52) U.S. Cl. 442/327; 442/328; 442/381; 442/306; 442/319; 442/182; 442/268

(57) ABSTRACT

Disclosed herein are color change laminate materials suitable for a variety of uses. The color change laminate materials include at least two layers of extensible materials having visually distinct coloration, and indicate a stretched or extended state by exposing the previously covered coloration of a lower layer. The color change laminate materials may also indicate the amount of stretching or extension is applied to the laminate. When the laminate includes elastic materials capable of stretch and recovery, the color change laminate materials may further be reversible color change laminate materials that can display color change upon extension and then recover the extension and return to the original coloration. Such color change laminate materials and reversible color change laminate materials are highly useful for use in garments or other textile type applications, in or on personal care products, protective wear products, health care and medical care products, bandages and the like.

### BACKGROUND OF THE INVENTION

Many of the medical care products, protective wear garments, and personal care products in use today rely on extensible and/or elastic fabric materials for improved fit and control, and improved functionality. Examples of such products include, but are not limited to, medical and health care products such as surgical drapes, gowns and bandages, protective workwear garments such as coveralls and lab coats, and infant, child and adult personal care products such as diapers, training pants, incontinence garments and pads, sanitary napkins, wipes and the like. Where extensible or elastic fabrics or materials are used, it is beneficial to be able to readily perceive by a visual cue or signal, when the material is or has been in an extended or stretched state.

For products such as the above, and for other types of products as well, attempts have been made to provide such a visual cue or signal that a certain event has occurred by developing materials that change color as a result of a particular trigger during the event. For example, a tamper evident bottle or jar cap seal uses encapsulated coloring agents or stress whitening of the plastic in the tamper evident cap seal to indicate that the cap has been twisted, permanently deforming the seal material. As another example, a personal care product uses organic or inorganic colorants that trigger upon activation by contact with water. As still another example, a protective wrap has a chemical-laden nonwoven web material under a shrink wrap film, and when the shrink-wrap film is breached the chemical reacts with air to change color and indicate that the breach has occurred. However, these previous materials rely on chemicals or additives to react upon the triggering event, or, in the stress whitening embodiment of the tamper seal, rely on permanent deformation to permanently whiten the seal's plastic.

Therefore, there remains a need for new materials capable of visually indicating when the material is in an extended state, or when the material has previously been extended, and/or returning to its original state with coincident removal of the visual indicator. Furthermore there remains a need for materials capable of indicating material extension without reliance on relatively expensive chemical color change additives, which chemicals may also be potentially unhealthful or have potentially environmentally deleterious effects.

### SUMMARY OF THE INVENTION

The present invention provides a color change laminate material. The color change laminate material includes at least a first extensible material and a second extensible material in face-to-face relation with the first extensible material. The first extensible material includes a plurality of slit openings and the first extensible material has a predominant coloration that is visually distinct from the predominant coloration of the second extensible material.

The color change laminate material may further include other layers, such as a third extensible material in face-to-face relation with the second extensible material. Such a third extensible material may have a predominant coloration that is visually distinct from the predominant coloration of the second extensible material, and/or that is visually distinct from the predominant coloration of the first extensible material. Either or both of a second and third extensible materials may desirably also include a plurality of slit openings. The first and/or second and/or third/other extensible materials may desirably be materials such as knit materials, woven materials and nonwoven materials, and film materials. In addition, the first and/or second and/or third/other extensible materials may desirably be elastic materials.

Also provided herein are products that include the color change laminate material, such as personal care products, protective wear product, stretch tab materials and elastic bandage materials, for example. Various features and aspects of the present invention are discussed in greater detail below.

### BRIEF DESCRIPTION OF THE DRAWINGS

FIG. 1 illustrates in perspective view a color change laminate material according to the present invention.

FIG. 2A-2B schematically illustrate in top plan view an embodiment of the color change laminate material of the present invention.

FIG. 3A-3C schematically illustrate in top plan view another embodiment of the color change laminate material of the present invention.

FIG. 4 schematically illustrates in top view an exemplary slit pattern for an extensible material used in the color change laminate material of the present invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries. As used herein the term “thermoplastic” or “thermoplastic polymer” refers to polymers that will soften and flow or melt when heat and/or pressure are applied, the changes being reversible.

As used herein the term “fibers” refers to both staple length fibers and substantially continuous filaments, unless otherwise indicated. As used herein the term “substantially continuous” with respect to a filament or fiber means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer composition. This is not meant to exclude fibers or filaments formed from one polymeric extrudate to which small amounts of additives have been added for color, anti-static properties, lubrication, hydrophilicity, etc.

As used herein the term “multicomponent fibers” refers to fibers or filaments that have been formed from at least two component polymers, or the same polymer with different properties or additives, extruded from separate extruders but spun together to form one fiber or filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al. and U.S. Pat. No. 5,336,552 to Strack et al. Conjugate fibers are also taught in U.S. Pat. No. 5,382,400 to Pike et al. and may be used to produced crimp in the fibers by using the differential rates of expansion and contraction of the two (or more) polymers. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein the terms “biconstituent fiber” or “multiconstituent fiber” refer to a fiber or filament formed from at least two polymers, or the same polymer with different properties or additives, extruded from the same extruder as a blend. Multiconstituent fibers do not have the polymer components arranged in substantially constantly positioned distinct zones across the cross-section of the multicomponent fibers; the polymer components may form fibrils or protofibrils that start and end at random.

As used herein the terms “nonwoven web” or “nonwoven fabric” refer to a web having a structure of individual fibers or filaments that are interlaid, but not in an identifiable manner as in a knitted or woven fabric. Nonwoven fabrics or webs have been formed from many processes such as for example, meltblowing processes, spunbonding processes, airlaying processes, and carded web processes. The basis weight of nonwoven fabrics is usually expressed in grams per square meter (gsm) or ounces of material per square yard (osy) and the filament diameters useful are usually expressed in microns. (Note that to convert from osy to gsm, multiply osy by 33.91).

The terms “spunbond” or “spunbond nonwoven web” refer to a nonwoven fiber or filament material of small diameter fibers that are formed by extruding molten thermoplastic polymer as fibers from a plurality of capillaries of a spinneret. The extruded fibers are cooled while being drawn by an eductive or other well known drawing mechanism. The drawn fibers are deposited or laid onto a forming surface in a generally random manner to form a loosely entangled fiber web, and then the laid fiber web is subjected to a bonding process to impart physical integrity and dimensional stability. The production of spunbond fabrics is disclosed, for example, in U.S. Pat. Nos. 4,340,563 to Appel et al., 3,692,618 to Dorschner et al., and 3,802,817 to Matsuki et al., all incorporated herein by reference in their entireties. Typically, spunbond fibers or filaments have a weight-per-unit-length in excess of about 1 denier and up to about 6 denier or higher, although both finer and heavier spunbond fibers can be produced. In terms of fiber diameter, spunbond fibers often have an average diameter of larger than 7 microns, and more particularly between about 10 and about 25 microns, and up to about 30 microns or more.

As used herein the term “meltblown fibers” means fibers or microfibers formed by extruding a molten thermoplastic material through a plurality of fine, usually circular, die capillaries as molten threads or filaments or fibers into converging high velocity gas (e.g. air) streams that attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are often smaller than 10 microns in average diameter and are frequently smaller than 7 or even 5 microns in average diameter, and are generally tacky when deposited onto a collecting surface.

As used herein “carded webs” refers to nonwoven webs formed by carding processes as are known to those skilled in the art and further described, for example, in U.S. Pat. No. 4,488,928 to Alikhan and Schmidt which is incorporated herein in its entirety by reference. Briefly, carding processes involve starting with staple fibers in a bulky batt that is combed or otherwise treated to provide a web of generally uniform basis weight.

Typically, the webs are thereafter bonded by such means as through-air bonding, thermal point bonding, adhesive bonding, and the like.

As used herein “coform” or “coformed web” refers to composite nonwoven webs formed by processes in which two or more fiber types are intermingled into a heterogeneous composite web, rather than having the different fiber types supplied as separate or distinct web layers, as is the case in a laminate composite material. Certain well-known coform processes are described in U.S. Pat. No. 4,818,464 to Lau and U.S. Pat. No. 4,100,324 to Anderson et al., the disclosures of which are incorporated herein by reference in their entireties, wherein at least one meltblown diehead is arranged near a chute or other delivery device through which other materials or fiber types are added while the web is being formed. Such other materials or fiber types disclosed in these patents include staple fibers, cellulosic fibers, and/or superabsorbent materials and the like.

As used herein, “thermal point bonding” involves passing a fabric or web of fibers or other sheet layer material to be bonded between a heated calender roll and an anvil roll. The calender roll is usually, though not always, patterned on its surface in some way so that the entire fabric is not bonded across its entire surface. As a result, various patterns for calender rolls have been developed for functional as well as aesthetic reasons. One example of a pattern has points and is the Hansen Pennings or “H&P” pattern with about a 30 percent bond area with about 200 bonds per square inch (about 31 bonds per square centimeter) as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen and Pennings or “EHP” bond pattern that produces a 15 percent bond area with a square pin having a side dimension of 0.037 inches (0.94 mm), a pin spacing of 0.097 inches (2.464 mm) and a depth of 0.039 inches (0.991 mm). Other common patterns include a high density diamond or “HDD pattern”, that comprises point bonds having about 460 pins per square inch (about 71 pins per square centimeter) for a bond area of about 15 percent to about 23 percent, a “Ramish” diamond pattern with repeating diamonds having a bond area of about 8 percent to about 14 percent and about 52 pins per square inch (about 8 pins per square centimeter) and a wire weave pattern looking as the name suggests, e.g. like a window screen. As still another example, the nonwoven web may be bonded with a point bonding method wherein the arrangement of the bond elements or bonding “pins” are arranged such that the pin elements have a greater dimension in the machine direction than in the cross-machine direction. Linear or rectangular-shaped pin elements with the major axis aligned substantially in the machine direction are examples of this. Alternatively, or in addition, useful bonding patterns may have pin elements arranged so as to leave machine direction running “lanes” or lines of unbonded or substantially unbonded regions running in the machine direction, so that the nonwoven web material has additional give or extensibility in the cross machine direction. Such bonding patterns as are described in U.S. Pat. No. 5,620,779 to Levy et al., incorporated herein by reference in its entirety, may be useful, such as for example the “rib-knit” bonding pattern therein described. Typically, the percent bonding area varies from around 10 percent to around 30 percent or more of the area of the fabric or web. Thermal bonding imparts integrity to individual layers or webs by bonding fibers within the layer and/or for laminates of multiple layers, such thermal bonding holds the layers together to form a cohesive laminate material.

### DETAILED DESCRIPTION OF THE INVENTION

The present invention provides a color change laminate material. The color change laminate material includes at least a first extensible material and a second extensible material, and the first extensible material has a predominant coloration that is visually distinct from the predominant coloration of the second extensible material. At least one of the layers of extensible material includes slit openings, and the slit openings are capable of expansion when the color change laminate material is extended in one or more directions, thereby exposing the visually distinct predominant coloration of one extensible material through the slit openings present on the other extensible material. The invention will be described with reference to the following description and Figures which illustrate certain embodiments.

It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and equivalents. In addition, it should be noted that any given range presented herein is intended to include any and all lesser included ranges. For example, a range of from 45-90 would also include 50-90; 45-80; 46-89 and the like. Thus, the range of 95% to 99.999% also includes, for example, the ranges of 96% to 99.1%, 96.3% to 99.7%, and 99.91% to 99.999%, etc.

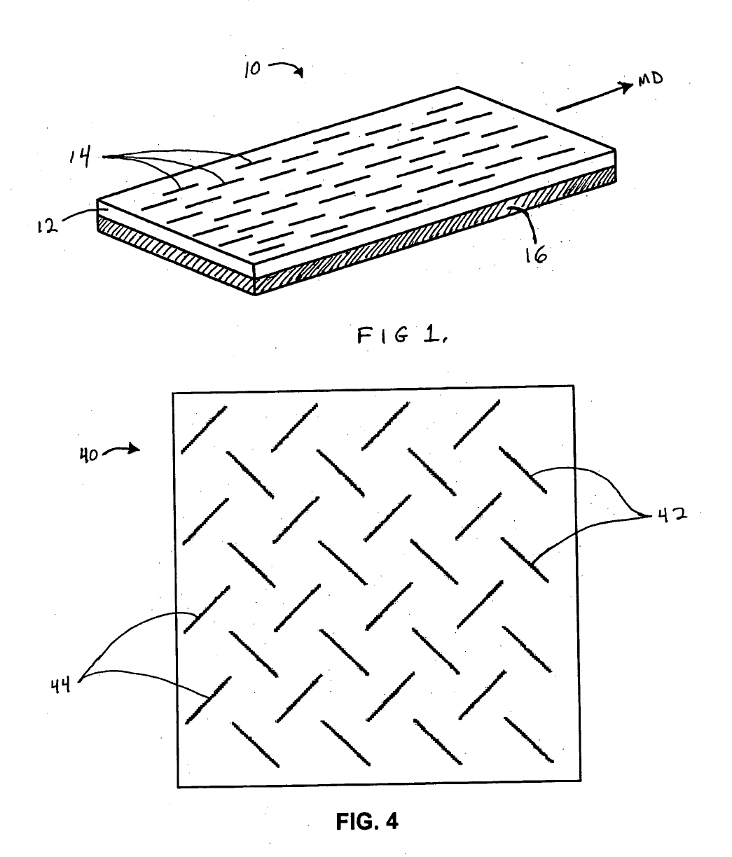

FIG. 1 shows in perspective view an illustration of a color change laminate material 10 according to the present invention. The color change laminate material 10 includes a first extensible material 12 in a face-to-face relation with (i.e., layered onto) a second extensible material 16. The first extensible material 12 includes a plurality of slit openings 14. As shown in FIG. 1, the slit openings 14 may be arranged as longitudinal cuts or slits in the first extensible material 12. The longitudinal or machine direction dimension of the material is shown in FIG. 1 as aligned with arrow MD. As shown, the slit openings 14 are arranged as a plurality of slits or cuts in longitudinal columns. Although not required, the longitudinal columns of slits as shown are arranged in an offset fashion, so that the mid point of each slit opening 14 in one longitudinal column of slits is aligned approximately with the non-slit space between slits in the neighboring or adjacent longitudinal column of slits. The longitudinal columns of slit openings as shown are spaced at regular intervals across the cross machine direction dimension (i.e., the material transverse direction, 90 degrees from the machine direction) of the first extensible material. The slit openings may be produced by any suitable method as is known in the art for providing slits or cuts into fibrous or film sheet-type materials, such as by means of an engraved slitting roller, rotary blades or knives, or by using intermittent high pressure jets of water (“water knife”), or laser cutters or other means known in the art. The slitting means may be employed at any time, such as forming the slits during an in-line process just after forming the extensible material, or in an in-line process just prior to incorporation of the extensible material into the color change laminate material, or at any point in time therebetween. In addition, the materials may be slit by hand, if desired, using conventional blades such as razors or knives.

As stated, the first extensible material 12 and second extensible material 16 should each have a predominant coloration that is visually distinct from the other. This feature is illustrated in FIG. 1 via the crosshatch shading shown on second extensible material 16. By “visually distinct” what is meant that a person viewing the material and having ordinary vision will be able to apprehend a difference between the predominant coloration of a first extensible material and the predominant coloration of a second extensible material when the two extensible materials are laid out side-by-side or laid in a partially overlapping fashion one onto the other, or in some similar fashion viewed together contemporaneously. By way of example only, the first extensible material 12 may have a predominantly white coloration, while the second extensible material 16 may have a predominantly dark coloration, such as a predominantly black coloration. Of course, while starkly contrasting predominant colorations are highly distinguishable (light color “A” vs. dark color “B”), this is not required and any color combinations including hues of the same color are acceptable. For example, a light blue with a navy blue, or any pastel color with a richer or deeper version of the same color. In addition, it is not necessary that the predominant coloration of the second extensible material becomes the predominant coloration of the color change laminate material itself when the color change laminate material is extended. For example, where a first extensible material is primarily yellow in coloration and the second extensible material is primarily blue in coloration, the color change laminate material when extended may appear to be primarily green in color. Other examples and combinations are of course possible.

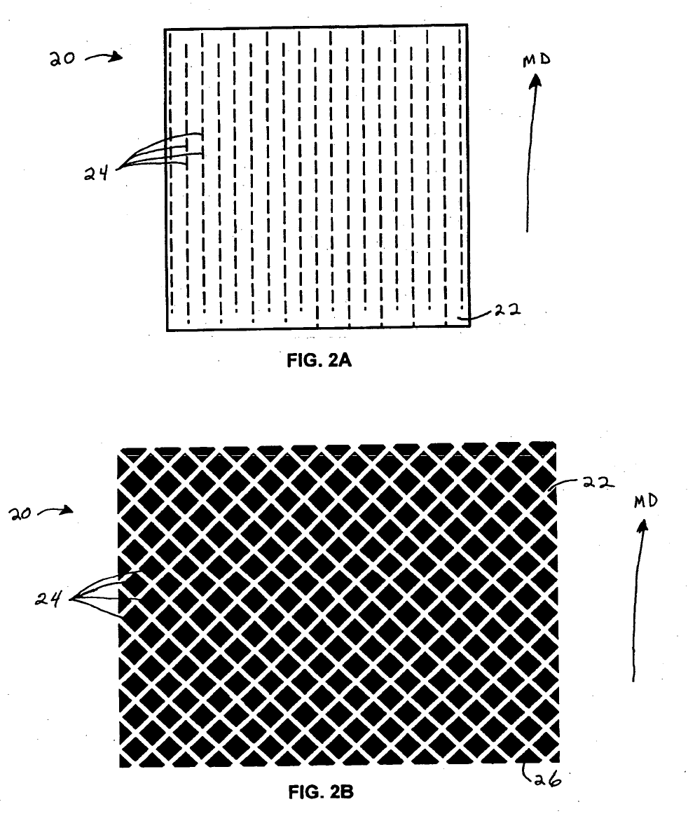

In any event, when the color change laminate material 10 is in a substantially non-extended state and viewed from the top of the material, the white color of the first extensible material 12 will be the coloration most visibly apparent to a viewer. Then, when the color change laminate material 10 is extended, the slit openings 14 will be expanded or opened, and the darker predominant coloration of second extensible material 16 will become visible through the slit openings 14, although as mentioned above, this may result in the visible appearance of a blend of the two colors. This phenomenon is more easily viewed by comparing FIGS. 2A and 2B.

Turning to FIG. 2A and FIG. 2B, an illustration of a color change laminate material 20 is shown in top plan view in a substantially non-extended state (FIG. 2A) and in an extended state (FIG. 2B). As shown in FIG. 2A, the first extensible material 22 of the color change laminate material 20 includes a plurality of slit openings 24 arranged as longitudinal cuts or slits in the first extensible material 22, and the slit openings 24 are arranged in longitudinal or machine direction oriented columns as indicated by arrow MD, and the columns are spaced at regular intervals across the cross machine direction dimension of the first extensible material 22. Although not required, the longitudinal columns of slits as shown are arranged in an offset fashion, similar to the arrangement shown in FIG. 1, so that the mid point of each slit opening 24 in one longitudinal column of slits is aligned approximately with the non-slit space between slits in the neighboring or adjacent longitudinal column of slits. As shown in FIG. 2A, the predominant coloration of the first extensible material 22 is a light color. Because the color change laminate material 20 in FIG. 2A is shown in top view (i.e., looking down upon first extensible material 22) and shown in a substantially non-extended state, the second extensible material 26 (FIG. 2B) is not visible in FIG. 2A. Turning to FIG. 2B, the color change laminate material 20 is shown in an extended state, after having been extended or elongated in the cross machine (transverse) direction. As illustrated in FIG. 2B, the slit openings 24 have been expanded or opened such that the predominant coloration of second extensible material 26, which is a darker coloration visually distinct from the lighter predominant coloration of first extensible material 22, is now readily apparent to a viewer and the overall visual appearance of the color change laminate material 20 has undergone a distinct change.

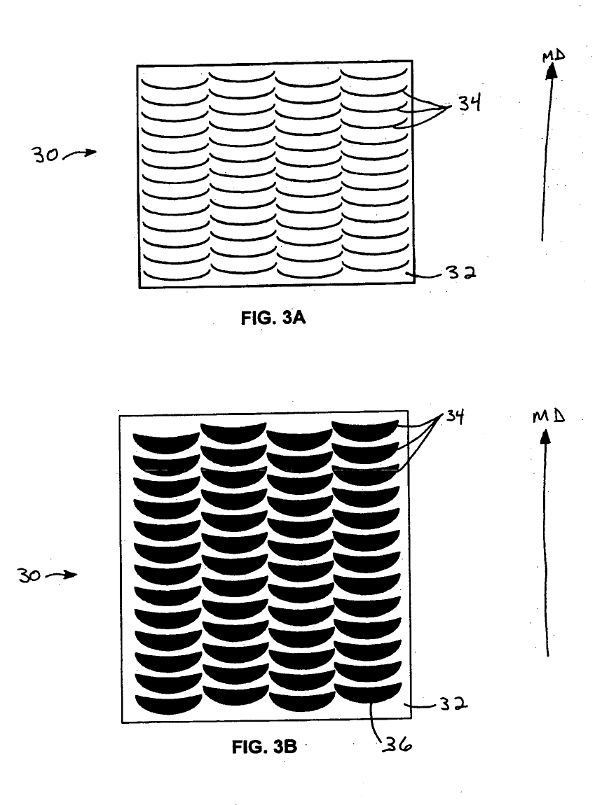

Turning to FIG. 3A and FIG. 3B, another illustration of a color change laminate material 30 is shown in top plan view in a substantially non-extended state (FIG. 3A) and in an extended state (FIG. 3B). As shown in FIG. 3A, the first extensible material 32 of the color change laminate material 30 includes a plurality of slit openings 34. Unlike the substantially linear or straight slit openings 24 in FIG. 2A, the slit openings 34 in first extensible material 32 are arcuate in shape like a mildly curved crescent, and are arranged as substantially horizontal or transverse cuts having a long axis in the cross machine direction (i.e., 90 degrees from the direction indicated by arrow MD). The slit openings 34 are arranged in longitudinal or machine direction oriented columns with the columns spaced at regular intervals across the cross machine direction dimension of the first extensible material 32. As with the arrangement of the columns of slit openings described above, the longitudinal columns of the crescent-like slits 34 as shown are arranged in an offset fashion with each column having slits slightly offset from the slits in its neighboring columns, although again use of an offset pattern is not required. Generally speaking, there are no limitations on the size and shape of slit openings or pattern or location or placement of slit openings to be used with an extensible material in any of the embodiments described herein, so long as the slit openings are capable of being expanded or opened when the color change laminate material is extended in at least one direction.

Returning to FIG. 3A, as illustrated the predominant coloration of the first extensible material 32 is a light color. Because the color change laminate material 30 in FIG. 3A is shown in top view (viewing down upon first extensible material 32) and shown in a substantially non-extended state, the second extensible material 36 (FIG. 3B) is not visible in FIG. 3A. Now turning to FIG. 3B, the color change laminate material 30 is shown in an extended state, after having been extended or elongated in the machine (longitudinal) direction, i.e., along the direction indicated by arrow MD. As illustrated in FIG. 3B, the crescent-shaped slit openings 34 have been expanded or opened to form a filled arc similar to a partial circular section, such that the predominant coloration of second extensible material 36, which is a darker coloration that is visually distinct from the lighter predominant coloration of first extensible material 32, is now readily apparent to a viewer and the overall visual appearance of the color change laminate material 20 has undergone a distinct change.

As stated above, there are no particular limitations on the size, shape, arrangement pattern or location/placement of slit openings to be used with an extensible material in any of the embodiments described herein, so long as the slit openings are capable of being expanded or opened when the color change laminate material is extended in at least one direction. However, one skilled in the art will recognize that generally speaking, in order to function as an expansible opening, the slits should be of a configuration capable of expanding in cooperation with the desired direction of extension of the color change laminate material. For example, slit openings having a discernable long axis, and having that long axis generally oriented in a different direction than the desired direction of extension of the color change laminate material, are quite useful.

As a specific example, for a color change laminate material that is desired to be extensible in the machine direction, having slit openings with a long axis generally oriented in the cross machine direction is helpful to the ability of the slit openings to open upon machine direction extension of the color change laminate material. Similarly, for a color change laminate material that is desired to be extensible in the cross machine direction, having slit openings with a long axis generally oriented in the machine direction is helpful to the ability of the slit openings to open upon cross machine direction extension of the color change laminate material. However, it is not necessary for the long axis of the slit openings to be oriented 90 degrees from the desired extension direction. The magnitude of the difference between slit openings axis direction and desired extension direction will depend on a number of factors, including overall level of extensibility of the color change laminate material, the size and shape of the slit openings, and the desired size or “width” of the slit openings when opened compared to the desired amount of extension to be applied to the color change laminate material. As a specific example, even a 5 to 10 degree difference in directions should result in a slit opening capable of some minimum desirable amount of expansion. More particularly, the difference between slit opening long axis direction and laminate material extension direction will be between about 20 and about 90 degrees, and still more particularly between about 30 and 90 degrees.

Turning to FIG. 4, there is illustrated in top view another exemplary slit pattern for an extensible material 40 that may be used in the color change laminate materials of the invention. The extensible material 40 has slit openings 42 that are oriented at an angle which is approximately negative 45 degrees (or 45 degrees “left”) from the machine direction of the extensible material 40 as indicated by arrow MD. The extensible material 40 further includes slit openings 44 that are oriented at an angle which is approximately positive 45 degrees (or 45 degrees “right”) from the machine direction of the extensible material 40. As shown in FIG. 4, the slit openings 42 may alternate with the slit openings 44 in a cross-hatched pattern. Such a cross-hatched pattern of slit openings may be highly suitable for use in a color change laminate material that is intended to be capable of extension in more than one discrete direction, that is, a “multi-direction” extensible color change laminate material.

As described above, the slit openings may generally be slits, that is, despite possible shape variations, the slit openings may desirably still have a discernable long axis, even if the slit opening does not describe a substantially straight line. However, as still another alternative to the slit openings described above having a discernable long axis, slit openings without a discernable long axis may also be used. As an example, the slit openings may be configured to be small circular openings or apertures that are small enough that little of the predominant coloration of the second extensible material is visible from the first extensible material side of the color change laminate material prior to expansion, but which expand or open up upon extension of the color change laminate material sufficiently to expose enough of the coloration of the second extensible material to present a readily visually apparent change in the coloration of the color change laminate material. In this situation, the visually distinct coloration of the color change laminate material prior to extension is primarily or mainly that of the predominant coloration of the first extensible material. Small circular slit openings may be particularly useful when the color change laminate material is desired to have multi-directional extensibility, i.e., be extensible in more than one discrete direction.

Still other alternatives are possible; for example, slit openings may be selected that have more than one discernable axis, as in the case of slit openings having an “X” shape, a “Y” shape, a “T” shape, and “H” shape, and the like. As with the cross-hatched slit opening placement pattern described above and the circular or non-axial slit openings, these multi-axial slit openings may be particularly useful in the case of desired multi-direction extensible color change laminate materials. It should be recognized that for materials having multi-directional extensibility, use of such slit openings having multi-directional axes can result in a color change laminate material that exhibits a differing color change phenomenon depending the direction in which it is extended, wherein when extended in one direction the color change laminate material exhibits a newly visible color “spot” having one shape, and when extended in another direction the color change laminate material exhibits the newly visible color as a “spot” having a differing shape.

Still other alternatives are possible. In the embodiments described above, it should be noted that the color change is only readily apparent when the color change laminate material is viewed from the side of the laminate material having the first extensible material, since this is the extensible material that includes the slit openings. Therefore, if the color change laminate material is viewed from the second extensible material side of the laminate material when the laminate it extended, the color change will not be readily apparent. Thus, if it is desired to utilize the color change laminate material in an application where either surface of the color change laminate material may be viewed when the laminate material is extended, it may be desirable to utilize a second extensible material also having slit openings. When utilizing a first extensible material and second extensible material both having slit openings, care should be taken to arrange the pattern of slit openings for the two materials such that the coincidence of the slit openings in the first extensible material with the slit openings in the second extensible material is avoided or minimized, to avoid creating apertures through the entire color change laminate material.

Alternatively, it may be desirable for certain applications to have a color change laminate material that will also provide apertures selectively (i.e., only upon extension). As still another alternative, it may be desirable for the color change laminate material to provide apertures only upon a certain degree or amount of extension. In that case, the patterns of slit openings in the first extensible material and second extensible material may be arranged such that the slit openings only coincide to a desired degree, or only begin to coincide (i.e., overlap) after a desired amount of extension has been applied to the color change laminate material and the slit openings have opened to a certain desired size or width. As a specific example, the respective patterns of slit openings may be arranged such that when the first extensible material and second extensible material are layered together in face-to-face relation, the locations of the slit openings of the first extensible material are far enough apart from the locations of the slit openings of the second extensible material that the respective slit openings only begin to overlap (and thus to provide an aperture through the laminate material) after the color change laminate material has been extended to, for example, an extension of 120 percent, or, as other examples, 130 percent or 140 percent of the color change laminate material's original unextended laminate dimension.

In still another embodiment, the color change laminate material may be a multi-layer laminate, i.e. have more than two extensible material layers. In this embodiment, like the embodiments described above having a first extensible material and second extensible material both having slit openings, it is possible to construct a color change laminate material having readily apparent color change properties when viewed from either surface of the laminate material. For example, a multi-layer color change laminate material may be constructed as a tri-layer laminate material by layering a first extensible material having slit openings and a first predominant coloration on a second extensible material having a second predominant coloration that is visually distinct from the predominant coloration of the first extensible material. A third extensible material may also be layered to the side of the second extensible material opposite from the first extensible material. The third extensible material may also have slit openings and may have a predominant coloration that is visually distinct from either or both of the predominant coloration of the first extensible material or second extensible material. In this way, a color change laminate material is constructed which, upon extension, will demonstrate a visually apparent color change whether viewed from the first extensible material side or the third extensible material side of the color change laminate material.

In yet still another embodiment, the color change laminate material may be constructed as a multi-layer laminate as in the tri-layer laminate material described immediately above, but be constructed to have different color change properties. As an example, a tri-layer color change laminate material may be constructed with a second extensible material sandwiched between a first extensible material and third extensible material as above, but wherein the second extensible material has slit openings instead of, or in addition to, the third extensible material having slit openings. As a more specific example, such a multi-layer color change laminate material may be constructed using a first extensible material with slit openings and a second extensible material also having slit openings, wherein the patterns of slit openings in the first extensible material and second extensible material are arranged such that the slit openings only coincide to a desired degree, such as was described in the case of the bi-layer laminate material above that provides apertures only upon a certain degree or amount of extension. However, in the case of this tri-layer laminate, when the slit openings of the first extensible material and second extensible material begin to coincide (i.e., overlap), instead of opening apertures the laminate material displays a second readily apparent color change phenomenon due to the predominant coloration of the third extensible material becoming visible.

As a specific example of the foregoing, consider a tri-layer color change laminate material having a first extensible material having a first predominant coloration and slit openings, a second extensible material having a second, visually distinct, predominant coloration and slit openings, with a third extensible material having a third predominant coloration that is visually distinct from the predominant coloration of the first and the second extensible materials. When viewed from the first extensible material side of the laminate material, it is possible to view a “three stage” color change phenomenon. First, in the non-extended state, the predominant coloration of the first extensible material is the coloration that is readily apparent to a viewer. Then, after the laminate material is extended to a certain desired amount, the slit openings of the first extensible material begin to expand or open and the coloration of the color change laminate material changes as the coloration of the second extensible material becomes visible through the expanding slit openings of the first extensible material. Then, after the laminate material is extended to a further desired amount, the slit openings of the first extensible material and the slit openings of the second extensible material have opened enough to begin to coincide or overlap, such that the coloration of the color change laminate material again changes as the coloration of the third extensible material becomes visible through the expanding slit openings of both the first extensible material and second extensible material.

Such a three-stage phenomenon is a very useful signaling mechanism and may be used to signal to a user the relative degree of extension that has been applied to the color change laminate material. This three-stage color change phenomenon may also be usefully employed to signal a caution status to a user. For example, the third color state may signal to a user of the color change laminate material that the useful extensibility of the laminate material has nearly been reached, and that further extension may risk rupturing the laminate material. Alternatively, the placement of the slit openings in the various layers and the extensibility of the various layers may be tailored to produce a color change laminate material that will indicate to a user when the laminate material has been extended to some desired or specified percentage of its maximum non-destructive extensibility. As another example, where the color change laminate material has elastic properties, such a laminate material may be usefully employed as an orthopedic limb/joint-care or a wound care bandage that could signal, in the first color state, that the bandage has not been wrapped tightly enough (i.e., not extended enough during wrapping operation) for therapeutic benefit. The three-stage laminate material could further signal that an appropriate amount of wrapping tension has been applied when the second color state becomes visible (i.e., when the predominant coloration of the second extensible material begins to become uncovered by the expanding first extensible material slit openings), and could still further signal that too much wrapping tension has been applied if the third color state becomes visible (i.e., if or when the predominant coloration of the third extensible material begins to become uncovered by the coincidence of the slit openings in the first and second extensible materials).

The three-stage color change phenomenon of the tri-layer color change laminate material described above may also be employed in a number of other useful applications. As an example, this color change laminate material may be used in any number of garments or other articles of wear as an indicator of proper fit. As a specific example, infant and child personal care absorbent products may be constructed having one or more stretch panels, or other components, made from or incorporating the color change laminate material. The product and color change laminate material component may be designed such that if the product size selected for the wearer is too large, the product's color change laminate material component will demonstrate the first color state when the product is donned. If the product size selected for the wearer is an appropriate fit, the product's color change laminate material component will demonstrate the second color state when the product is donned. Finally, if the product size selected for the wearer is inappropriately small, the product's color change laminate material component will demonstrate the third color state when the product is donned.

As has been stated, the individual layers of material making up the color change laminate material need to be extensible. An extensible material is a material that, upon the application of a biasing force, must be capable of being extended or stretched or elongated, in at least one direction, without rupturing, to an extended or elongated dimension which is at least 110 percent of the material's non-extended or “unstretched” dimension. By way of example only, an extensible material having a relaxed or unstretched length of 10 centimeters may be elongated to at least about 11 centimeters by the application of an extending or biasing force. Desirably, an extensible material may be stretched or elongated without catastrophic failure to an extended, biased length which is at least about 120 percent its relaxed, unstretched length. For many uses or applications, it is desirable for the material to be extensible to at least 130 percent of its unstretched length or dimension, and for other uses it is desirable for the material to be extensible to at least 150 percent, or even 200 percent (or even more) of its unstretched length or dimension.

An extensible material such as a fibrous web material may be extensible because of, for example, fiber-over-fiber slippage or via use of elastic or stretchable component materials. Also, multicomponent fibers which can be crimped may be utilized, which may lend a certain amount of extensibility to the web via straightening out of the fiber crimps upon the application of an extending force. In addition, materials that have been previously gathered in a direction are generally extensible in a direction that is largely or substantially parallel to the direction of gathering. Gathered materials are further described in U.S. Pat. No. 4,720,415 to Vander Wielen et al. The list is not intended to be exhaustive but merely exemplary of the ways in which a material may have suitable extensibility, and of course an extensible material may be extensible simply by virtue of having slit openings in the material that expand or open up upon the application of the extending force, thereby allowing the material as a whole to extend.

In addition to the above-mentioned extensible fibrous materials, extensible film materials and particularly extensible polymeric films, such as thermoplastic polymeric films, may be utilized. An extensible film material may be extensible by virtue of, for example, use of elastic or stretchable component materials, or simply due to the plastic nature of polymeric films, such as by undergoing a geometric deformation (e.g., stretch thinning) upon the application of an extending force, or by virtue of having slit openings as mentioned above with respect to fibrous extensible materials. For either fibrous materials or film materials that do not have inherent or as-produced extensibility (or are not deemed to have sufficient levels of extensibility for a particular use or application), it should be noted that the extensibility of sheet-form materials such as fibrous web materials and film materials may be enhanced or increased by various mechanical treatments as are known in the art, and exemplary such mechanical treatments are described hereinbelow in more detail.

As stated, the layers used in the construction of the color change laminate material should be extensible materials. In addition, any or all of the layers used may be elastic materials; that is, the extensible materials may also have elastic properties of stretch or extension with substantial recovery of the extension amount towards the original length of the material (i.e., the length of the material prior to being extended). As used herein, an extensible material that is elastically extensible will recover at least about 50 percent of the amount or length the material was extended. By way of example only, an elastic extensible material having a relaxed or unstretched length of 10 centimeters may be elongated to at least about 11 centimeters by the application of an extending or biasing force, and, upon release of the extending force, the elastic extensible material will recover to a length of not more than 10.5 centimeters. Desirably, an elastic extensible material will recover at least about 60 percent or more of the extension length. Depending on the desired use or application, an elastic extensible material may desirably be capable of recovering about 75 percent, or even about 85 percent or more of the extension length, and for still other uses an elastic extensible material may desirably be capable of recovering substantially all of the extension length. In addition, as with the extensible materials described above, depending on desired use, elastic extensible materials when utilized in the color change laminate material may desirably be capable of being extended more than 110 percent; e.g. as much as 120 percent, 130 percent, 150 percent, 200 percent or even more of the original, unstretched dimension or length.

It should also be noted that where the color change laminate material is constructed of extensible materials that are not elastic extensible materials, the color change laminate material may recover some portion of the extension length but not as much as 50 percent. In this regard, then, once extended such a non-elastic color change laminate material will tend to continue displaying a substantial amount of the second extensible material's predominant coloration once it has been extended, even after releasing of the extending force. On the other hand, a color change laminate material including one or more elastic extensible materials may be considered to be a “reversible” color change laminate material. Because an elastic color change laminate material will recover a substantial percentage, and potentially all or nearly all of the extension length, an elastic color change laminate material may be repeatedly extended and allowed to recover upon release of the extending force, thereby being capable of reversible color change, by first displaying and then in turn occluding the predominant coloration of the second extensible material or other extensible materials.

Although we believe the color change laminate material of the invention may be usefully constructed using any suitably extensible materials, nonwoven web materials and thermoplastic polymeric film materials, and/or nonwoven-film laminate materials, may be particularly useful as the extensible materials due to their ease of manufacture and handling, and also because of their relative inexpense in comparison to textile type materials such as woven cloth materials and knitted materials. Nonwoven web materials include such as spunbond webs, meltblown webs, carded staple fiber webs, coform webs, hydroentangled fiber webs, and the like. The production of such individual web layers is well known in the art and described briefly or referenced herein, and therefore will not be discussed here in detail. Film materials include cast and blown films as are known in the art and may be single layer films, multi-layer films, microporous and monolithic breathable films, and the like. Processes for forming blown and cast films are well known in the art and will not be discussed herein in detail. Briefly, the production of a blown film involves use of a gas, such as air, to expand a bubble of molten extruded polymer after the molten polymer has been extruded from an annular die. Processes for producing blown films are taught in, for example, U.S. Pat. Nos. 3,354,506 to Raley, 3,650,649 to Schippers and 3,801,429 to Schrenk et al., each of which is incorporated herein by reference in its entirety.

Generally speaking, the basis weights of any of the extensible materials used in the construction of the color change laminate material, whether extensible or elastically extensible, and whether a film layer or a fibrous layer, may suitably be from about 7 grams per square meter (“gsm”) or less up to 200 gsm or more, and more particularly may have a basis weight from about 10 gsm or less to about 100 gsm, and still more particularly, from about 14 gsm to about 68 gsm. The basis weight of the color change laminate material itself will of course depend on the number of extensible material layers utilized and the individual basis weights of the extensible material layers, but will generally be from about 15 gsm to about 400 gsm, or more. Nonwoven web materials and polymeric film materials may desirably be formed from or made using thermoplastic polymers, and/or may desirably be formed from or made using elastic polymers and/or elastic thermoplastic polymers.

Polymers suitable for making polymeric films and fibrous webs include those polymers known to be generally suitable for making films and nonwoven webs such as spunbond, meltblown, carded webs and the like, and such polymers include for example polyolefins, polyesters, polyamides, polycarbonates and copolymers and blends thereof. It should be noted that the polymer or polymers may desirably contain other additives such as processing aids or treatment compositions to impart desired properties to the fibers, residual amounts of solvents, pigments or colorants and the like.

Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(lactide) and poly(lactic acid) polymers as well as polyethylene terephthalate, polybutylene terephthalate, polytetramethylene terephthalate, polycyclohexylene-1,4-dimethylene terephthalate, and isophthalate copolymers thereof, as well as blends thereof.

Many elastomeric polymers are known to be suitable for forming extensible materials that are also elastic, i.e., materials that exhibit properties of stretch and recovery, such as elastic fibers and elastic fibrous web layers, and elastic film materials. Thermoplastic polymer compositions may desirably comprise any elastic polymer or polymers known to be suitable elastomeric fiber or film forming resins including, for example, elastic polyesters, elastic polyurethanes, elastic polyamides, elastic co-polymers of ethylene and at least one vinyl monomer, block copolymers, and elastic polyolefins. Examples of elastic block copolymers include those having the general formula A-B-A′ or A-B, where A and A′ are each a thermoplastic polymer endblock that contains a styrenic moiety such as a poly (vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from Kraton Polymers U.S., L.L.C. of Houston, Tex. under the trade designation KRATON®. Other commercially available block copolymers include the SEPS or styrene-poly(ethylene-propylene)-styrene elastic copolymer available from Kuraray Company, Ltd. of Okayama, Japan, under the trade name SEPTON®.

Examples of elastic polyolefins include ultra-low density elastic polypropylenes and polyethylenes, such as those produced by “single-site” or “metallocene” catalysis methods. Such polymers are commercially available from the Dow Chemical Company of Midland, Mich. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from the ExxonMobil Chemical Company of Houston, Tex., as well as blends. Still other elastomeric polymers are available, such as the elastic polyolefin resins available under the trade name VISTAMAXX from the ExxonMobil Chemical Company, Houston, Tex., and the polyolefin (propylene-ethylene copolymer) elastic resins available under the trade name VERSIFY from Dow Chemical, Midlands, Mich.

Where one or more of the extensible materials of the color change laminate material is an extensible or elastically extensible film material layer, it may be desirable for a film layer to be breathable. Textile type fibrous fabrics such as woven or knitted materials, and fibrous nonwoven materials such as meltblown and spunbond layers, are inherently breathable; that is, fibrous materials are generally capable of transmitting gases and water vapors. Film layers, however, generally act as a barrier to the passage of liquids, vapors and gases. If the color change laminate material is used in a skin-contacting application, a film layer that is breathable may provide increased in-use comfort to a wearer by allowing passage of water vapor and assist in reducing excessive skin hydration, and help to provide a more cool feeling. Therefore, where one or more film layers are selected for use in the color change laminate material it may be desirable to use a breathable monolithic or microporous film.

Monolithic breathable films can exhibit breathability when they comprise polymers that inherently have good water vapor transmission or diffusion rates such as, for example, polyurethanes, polyether esters, polyether amides, EMA, EEA, EVA and the like. Examples of elastic breathable monolithic films are described in U.S. Pat. No. 6,245,401 to Ying et al., incorporated herein by reference in its entirety, and include those comprising polymers such as thermoplastic (ether or ester) polyurethane, polyether block amides, and polyether esters. Microporous breathable films contain a filler material, such as for example calcium carbonate particles, in an amount usually from about 30 percent to 70 percent by weight of the film. The filler-containing film (or “filled film”) opens micro-voids around the filler particles when the film is stretched, which micro-voids allow for the passage of air and water vapor through the film. Exemplary breathable films are described in, for example, U.S. Pat. No. 6,114,024 to Forte, U.S. Pat. No. 6,309,736 to McCormack et al, and U.S. Pat. No. 6,037,281 to Mathis et al., all incorporated herein by reference in their entireties. Breathable microporous elastic films containing fillers are described in, for example, Pat. Nos. 6,015,764 and 6,111,163 to McCormack and Haffner, U.S. Pat. No. 5,932,497 to Morman and Milicevic, and in U.S. Pat. No. 6,461,457 to Taylor and Martin, all incorporated herein by reference in their entireties. In addition, multi-layer breathable films as are disclosed in U.S. Pat. No. 5,997,981 to McCormack et al., incorporated herein by reference in its entirety, may be useful. Another example of a film that can exhibit breathability is a cellular elastic film, such as may be produced by mixing a polymer or an elastic polymer with a cell opening agent that decomposes or reacts to release a gas that forms cells in the elastic film. The cell opening agent can be an azodicarbonamide, fluorocarbons, low boiling point solvents such as for example methylene chloride, water, or other agents such as are known to those skilled in the art to be cell opening or blowing agents that will create a vapor at the temperature experienced in the film die extrusion process. Cellular elastic films are described in U.S. Pat. No. 6,855,424 to Thomas et al., incorporated herein by reference in its entirety.

Of course, if an extensible or elastically extensible film layer is the selected for use as a layer in the color change laminate material, but liquid barrier properties are not particularly important or are not desired, the film layer itself may be used as the extensible material layer or layers having the slit openings, and thereby be made capable of allowing the passage of vapors or gases.

As has been stated, the color change laminate material is constructed of two or more extensible materials that are layered in face-to-face relation into a laminate material. The laminate material may simply be two or more extensible materials layered together as described; however, a certain amount of layer-to-layer attachment may be more desirable to prevent inadvertent delamination of the component extensible materials of the color change laminate material. For a color change laminate material of known desired size and shape, it may be desirable to have the layers attached only about the periphery (or a portion of the periphery) of the desired shape. Alternatively, it may be desirable to have the extensible material layers attached together intermittently across the length and/or width extent of the color change laminate material, either in a random arrangement of attachment sites or in a patterned attachment site arrangement. Such attachment may be by any suitable methods as are known in the art, such as by sewing or stitch bonding, hydroentangling, thermal bonding such as thermal “spot” or “point” bonding, ultrasonic bonding, adhesive bonding, and so forth. Where adhesive bonding is selected, extensible adhesives or adhesives having some elastic properties such as are known in the art may be particularly useful.

Although the component materials included in the color change laminate material have been described primarily with respect to single-layer materials, any or all of the individual extensible materials used in the color change laminate material may also be laminates or composite materials. For example, the first extensible material and/or the second extensible material, and/or any additional material layers, may desirably be laminate materials. Particular examples of multi-layer laminate construction for the extensible material layers include nonwoven-nonwoven laminates such as spunbond-meltblown laminates, spunbond-meltblown-spunbond laminates, spunbond-spunbond laminates, spunbond-carded web laminates, and the like. Other examples include one or more nonwoven layers laminated with one or more film layers. Such individual laminate layers used in the color change laminate material may be elastic or extensible (or capable of being made extensible). Examples of elastic laminate materials known in the art include the cross machine direction extensible and elastic laminate materials disclosed in U.S. Pat. Nos. 5,336,545, 5,226,992, 4,981,747 and 4,965,122 to Morman, and the machine direction extensible and elastic laminate materials disclosed in Vander Wielen et al. U.S. Pat. No. 4,720,415, incorporated herein by reference in its entirety. As disclosed by Vander Wielen et al., a material may bonded to an elastic material while the elastic material is held stretched, so that when the elastic material is relaxed and retracts, the material gathers between the bond locations, and the resulting laminate material is extensible or stretchable to the extent that the material is gathered between the bond locations and thereby allows the elastic material to be extended.

As mentioned above, in certain cases it may be desirable to provide extensibility to a material having little or no natural or inherent extensibility, or it may be desirable to increase the extensibility of a material to be used as one of the extensible materials in the color change laminate material. For example, for spunbonded materials formed from non-elastic resins it may be desirable to impart additional extensibility by mechanical treatment means as are known in the art. For example, a web material may be stretched in the machine direction by passing the web through two or more pairs of driven nipped rollers, wherein an upstream pair of driven rollers is driven at a first velocity, and a downstream pair of driven rollers is driven at a second velocity that is greater than the first velocity. Because the second velocity is greater than the first velocity, the material will experience a machine direction tensioning force or biasing force as it travels through the two nips. This machine direction tensioning force will cause the material to be stretched or extended in the machine direction, and cause the material to “neck” or somewhat decrease its cross machine direction dimension or width. If the necked material is bonded or set or otherwise held in this necked conformation, it is capable of extensibility in the cross machine direction to reverse the necking. Alternatively, if a necked material is allowed to retract toward its original length dimension, it will be more extensible in the machine direction upon subsequent attempted extension, compared to a material that has not been so treated. Necking may also be accomplished, and potentially to a greater extent, by drawing machine direction tension on a web over a longer span than typically used with the nip-to-nip drawing or tensioning described above. In addition, heat may be applied to the web during the necking process to aid the drawing and to help set the web in the necked conformation. Such reversibly necked materials are described in greater detail in the above-mentioned U.S. Pat. Nos. 5,336,545, 5,226,992, 4,981,747 and 4,965,122 to Morman, all incorporated herein by reference in their entireties.

Machine direction drawing of materials may also be accomplished where desired by a non-nipped roller assembly having multiple driven rollers in a vertical stack, which is referred to as a “machine direction orienter” or MDO unit. The material travels through the roller stack in an alternating or “S” wrap or “serpentine” wrap fashion, such that the material contacts a first driven roller with one planar material surface, a second driven roller with the opposite planar material surface, a third roller with the first planar material surface again, and so on. Each subsequent driven roller is driven at a speed slightly higher than the previous roller, which elongates or extends the material in the machine direction. Still another method for machine direction stretching of a moving material includes passing the material through a nipped pair of rollers having a gear-tooth type surface engraving that creates channels (or grooves) and high points (or teeth) in the surfaces of the rollers, which channels and high points run parallel to the longitudinal axis of the rollers. The high points or teeth on one roller fit or match within the channels of the other roller when the two rollers are engaged or brought together in face-to-face relation. As the material passes between the engaged rollers the teeth on the first roller stretch the material down into the channels on the second roller, thereby imparting a machine direction extension to the material. As above, such a material treated by an initial machine direction extension will be more easily extensible in the machine direction upon subsequent attempted extension, compared to a material that has not been so treated.

It may also or alternatively be desirable to impart or increase the transverse or cross machine direction extensibility of a material. This may be done by performing an initial stretching or extension of a material in the cross machine direction by such methods as are known in the art, for example by use of tenter frames and grooved rollers. Grooved rollers may be more desirable for cross machine direction extending because sheet materials such as fibrous web materials and film materials may have a tendency to develop longitudinal tears under an applied cross machine direction biasing or extending force. Grooved rollers may be constructed from a series of spaced disks or rings mounted on a mandrel or axle, or may be a series of spaced circumferential peaks and grooves cut into the surface of a roller. A pair of matched grooved rollers is then engaged or brought together with the peaks of one roller fitting into the grooves of the other roller, and vice versa, to form a “nip”, although it should be noted that there is no requirement for actual compressive contact between the solid parts of the two rollers. Grooved rollers as are known in the art are described as imparting an “incremental stretching” because the whole transverse width of a web material may be stretched by what amounts to a large number of small scale stretches or extensions (between each peak-to-peak distance) aligned along the transverse or cross machine direction of the material, which are less likely to cause tears than gripping the side edges of a material and applying a stretching force to the web as a whole, such as may be done via tentering. Such a cross machine direction stretched material may subsequently be retracted toward or to its original width dimension, and upon subsequent attempted extension will be more easily extensible in the cross machine direction compared to a material that has not been so treated.

In addition, the color change laminate material may initially be produced in a state or form having little or no extensibility, with the laminate extensibility to be “activated” by one or more of the machine direction or cross machine direction stretching methods hereinabove described, or by other methods known in the art. As a specific example, the first extensible material may be a fibrous or film material including a plurality of slit openings, which is then laminated to a second material having low or no initial extensibility, such as a non-elastic thermoplastic fibrous spunbonded web material. After the first and second materials are laminated, the extensibility of the second material (and thus the color change laminate material as a whole) may be activated by mechanically treating the entire laminate to an initial machine or cross machine direction stretch or extension treatment. Production of such a low initial extensibility color change laminate material may be desirable for ease of winding the laminate material onto rolls and subsequent storage and/or transport of the laminate material in roll good or other form. For example, where the laminate material is to be converted into a product, or converted as a component part of a product, such a color change laminate material may be transported to the product conversion facility in an as-produced low initial extensibility state, and only have the laminate extensibility activated by stretching or extending at the product conversion facility that manufactures the product.

Still other alternative constructions for the color change laminate material are possible and are within the scope of the invention. As one example, a color change laminate material may be constructed with a first extensible material having slit openings layered over two second extensible materials that are edge-joined together as or like adjacent panels. If the two different second extensible materials also have differing predominant colorations, when the color change laminate material is extended as a whole there will be certain areas of the color change laminate material that change color in one way, and other areas of the color change laminate material that change color in a differing way. As a specific example, consider a white colored first extensible material layered over a second extensible material that is made from edge-joined red and blue materials. Upon extension, the color change laminate material will show the blue color through the slit openings covering the blue extensible material and show the red color through the slit openings of the portion of the first extensible material covering the red extensible material.

As another alternative, a first extensible material may cover a second extensible material made from two edge-joined adjacent panels, wherein one of the panels is a substantially non-extensible material. Such a color change laminate material is still extensible due to the extensible portion or panel of the second extensible material, but may exhibit interesting color change phenomena when extended. For example, consider a color change laminate material having a length and width of 10 units, made from a 10×10 first extensible material covering a 10×10 second extensible material that is made from two 5×10 edge-joined adjacent panels, one of which is extensible, the other substantially non-extensible. As the color change laminate material is extended from a relatively lower level of extension through a relatively higher level of extension, the slit openings in the first extensible material will go from initially exposing similar amounts of color from each of the two panels in the second extensible material, to subsequently (as the color change laminate material is further extended) displaying relatively larger amounts of the coloration from the extensible panel and relatively less of the coloration of the substantially non-extensible panel.

As an example, when this 10×10 color change laminate material is extended to 110 percent it becomes 11 units long, and the extensible and non-extensible panels in the second extensible material are now 6 and 5 units long, respectively. Therefore, for a color change laminate material having a symmetric pattern of slit openings, the coloration that is now visible through the slit openings for each of the two panels is still similar. However, when the same color change laminate material is extended to 200 percent it becomes 20 units long, and the extensible and non-extensible panels in the second extensible material are now 15 units and 5 units long, respectively. Therefore, at this point the overall coloration change that is visible on the first extensible material face of the color change laminate material is 75 percent due to the coloration of the extensible panel in the second extensible material and only 25 percent due to the coloration of the substantially non-extensible panel. Stated another way, there would be three times as much of the extensible panel's coloration visible as the non-extensible panel's coloration.

Still other alternatives are possible. Besides the edge-joined adjacent panels mentioned above, either or both of the first extensible material or second extensible material may be a side-by-side coextruded film or fibrous web material having alternating stripes or other regions of differing predominant coloration, in order to provide color change laminate materials that exhibit differential color change in different areas or regions of the color change laminate material. Alternatively, stripes or geometric figures or the like having differing coloration may be printed onto films and fibrous materials to obtain color change laminate materials exhibiting differential color change in different areas or regions of the color change laminate material. As still other alternatives, it should be recognized that for materials having multi-directional extensibility, use of such differentially colored materials can result in a color change laminate material that exhibits a differing color change depending the direction in which it is extended.

While not described in detail herein, various additional potential processing and/or finishing steps as are known in the art for processing of fibrous web materials and film materials may be performed on the color change laminate material and/or on the component materials of the color change laminate material without departing from the spirit and scope of the invention. Examples of additional processing include such as the application of treatments, printing of graphics, or further lamination of the color change laminate material with other materials, such as additional film or fibrous material layers. General examples of material treatments include electret treatment to induce a permanent electrostatic charge in webs and/or films, or in the alternative antistatic treatments, or one or more treatments to impart wettability or hydrophilicity to a material comprising hydrophobic materials. It should also be noted that wettability treatment additives, if desired, may be incorporated into a polymer melt as an internal treatment during the production of an individual component material layer, or may be added topically at some point following the formation of an individual component material layer. Still another example of a material treatment includes treatment to impart repellency to low surface tension fluids such as alcohols, aldehydes, ketones, and surfactant laden aqueous liquids. Examples of such liquid repellency treatments include fluorocarbon compounds that may also be added to an individual component material layer either topically or by adding the treatment internally to a polymer melt during the production of the material layer.

### EXAMPLE

As a specific example of an embodiment of the foregoing, a color change laminate material was produced as follows. The color change laminate material was produced as a two-layer material, where each of the individual layers was itself a laminate material having two layers. The first extensible material was a laminate of a necked 0.4 osy (about 13.6 gsm) white colored spunbond nonwoven material available from Pegas A.S. (Czech Republic) that was laminated to a 23 gsm (about 0.7 osy) white colored blown elastic film made from about 70 percent by weight metallocene catalyzed polyethylene (AFFINITY® resin from the Dow Chemical Company, Midland, Mich.) and about 30 percent by weight of a calcium carbonate concentrate pellet designated SCC21382 by its manufacturer, Standridge Color Corp. of Social Circle, Ga. This film was extended past its plastic deformation limit in order to cause it to stress whiten. The spunbond was necked 45 percent by extending the spunbond in the machine direction (thereby decreasing its width in the cross machine direction) until its width was 55 percent of its starting width. As necked, the basis weight of the spunbond nonwoven was about 0.6 osy (about 20 gsm). The necked spunbond nonwoven and the white film were then laminated by adhesively securing them together using a commercially available hot melt and pressure sensitive adhesive designated H9375 by its manufacturer, Bostik Findley Adhesives, Inc., of Wauwatosa, Wis.

This white colored first extensible material laminate was then slit with a plurality of slit openings that penetrated through both individual materials in the first extensible material laminate. The slits were produced using a table press having steel cutting die to produce a slit pattern similar to the slit pattern illustrated in FIG. 2A. The slits were about 0.25 inch (about 0.63 centimeter) long slits that were oriented with the slit longitudinal axis running in the machine direction. In each longitudinal column of slits, the spacing between slits was about 0.25 inch (about 0.63 centimeter). The longitudinal columns of slit openings were arranged as illustrated in FIG. 2A such that the longitudinal columns of slits were spaced about 0.125 inches (about 0.32 centimeters) apart in intervals across the cross machine direction of the first extensible material laminate. In addition, the columns of slit openings were arranged in an offset fashion, such that the mid point of each slit in one longitudinal column of slits was aligned approximately with the mid point of the non-slit space between slits in the neighboring or adjacent longitudinal column of slits.

The second extensible material was also a two-material laminate. The second extensible material included the same type of necked 0.4 osy (about 13.6 gsm) (basis weight after necking at 45 percent was about 0.6 osy or about 20 gsm) spunbond nonwoven material mentioned above with respect to the first extensible material. The necked spunbond was laminated to a 50 gsm (about 1.5 osy) royal blue colored blown elastic film made from about 44 percent by weight KRATON® 6673 elastic styrenic block copolymer, available from Kraton Polymers U.S., L.L.C., (Houston, Tex.), about 44 percent by weight metallocene catalyzed polyethylene (the above-mentioned AFFINITY® resin), and about 2 percent by weight of the above-mentioned calcium carbonate concentrate pellet SCC21382. In addition, the film contained less than about 1 percent by weight of a blue pigment concentrate pellet, designated SCC01SAM0993 by its manufacturer, the Standridge Color Corp. of Social Circle, Ga., to provide the royal blue color to this film. The necked spunbond and the royal blue elastic film were laminated together to form the second extensible material laminate via thermal point bonding using a “Ramish” bond pattern as hereinabove described.

The first extensible material laminate and the second extensible material laminate were then used to form the sample color change laminate material. The first and second extensible material laminates were placed in face-to-face relation with the white film and blue film adjacent to one another and with the spunbond materials forming both exterior surfaces of the color change laminate material. Because each of these first and second extensible laminates included necked spunbond layers that were most easily extensible in the cross machine direction, the first and second laminates themselves were also most easily extensible in the cross machine direction. Therefore, when the two laminates were placed in facing relation they were oriented with the machine direction of both laminate materials aligned so as to form a color change laminate material having a high level of extensibility in the cross machine direction. The two extensible material laminates were bonded together along the edge periphery of the sample using a Branson ultrasonic welder (available from the Branson Ultrasonics Corporation of Danbury, Connecticut) to form a bonded color change laminate material. The color change laminate material samples so made were about 4 inches by about 4 inches (about 10 by 10 centimeters).

When in the unextended state, and looking on the first extensible material surface, the color change laminate material was white. However, as the color change laminate material was extended, the royal blue color of the second extensible material film became visible through the expanding slit openings, changing the color appearance of the color change laminate material to white with blue dots or spots. From a slight distance of about 10 feet (about 3 meters) away, the color appearance of the color change laminate material changed from white to light blue and back to white as the color change laminate material was taken from non-extended state to extended state and then allowed to elastically retract back to its non-extended state. The thus-formed color change laminate material was extensible to at least 200 percent in the cross machine direction without rupturing or breaking.

The color change laminate materials disclosed herein are highly suitable for use as individual sheets, protective covers or wraps, or as or as components in health care and medical care products, protective workwear garments, personal care products and other products or applications where an extensible or elastic material is desired and it is further desirable to have a visual indication that the material has been stretched or extended. Examples of such products include, but are not limited to, medical or healthcare products such as bandages, medical protective wear products such as surgical drapes and surgeon or patient gowns, work protective wear products such as coveralls and lab coats, and infant, child and adult personal care products such as diapers, training pants, incontinence garments and pads, sanitary napkins, wipes and the like. Non-limiting examples of use in such products as medical protective wear and work protective wear products include sleeves, or wrist cuffs, elbow patches and shoulder regions of the sleeves of such garments. Non-limiting examples of use in such products as personal care products include use as extensible or stretchable liner or coverstock materials, side panel materials, outer cover materials, waistband materials. Other uses include use as or as part of stretch “ear” or stretch tab materials used as part of a mechanical attachment or fastening system (e.g., a hook and loop fastener) for personal care product and work and medical protective wear products. The color change laminate materials provide the benefits of enhanced comfort provided by extensibility and/or elasticity when utilized in garment or personal care applications. Furthermore, the color change laminate materials provide a means of signaling extension and/or levels of extension by a distinctive visual cue.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. A color change laminate material comprising a first extensible material, said first extensible material comprising a plurality of slit openings and said first extensible material having a predominant coloration, and a second extensible material in face-to-face relation with said first extensible material, said second extensible material having a predominant coloration that is visually distinct from said predominant coloration of said first extensible material.

2. The color change laminate material of claim 1 wherein said first extensible material is selected from the group consisting of knit materials, woven materials and nonwoven materials.

3. The color change laminate material of claim 2 wherein said first extensible material is a nonwoven material.

4. The color change laminate material of claim 1 wherein said first extensible material is an elastic material.

5. The color change laminate material of claim 1 wherein said second extensible material is an elastic material.

6. The color change laminate material of claim 5 wherein said first extensible material is an elastic material.

7. The color change laminate material of claim 1 wherein said second extensible material comprises a plurality of slit openings.

8. The color change laminate material of claim 1 further comprising a third extensible material in face-to-face relation with said second extensible material.

9. The color change laminate material of claim 8 wherein said third extensible material comprises a plurality of slit openings.

10. The color change laminate material of claim 9 wherein said third extensible material has a predominant coloration that is visually distinct from said predominant coloration of said second extensible material.

11. The color change laminate material of claim 8 wherein said second extensible material comprises a plurality of slit openings.

12. The color change laminate material of claim 11 wherein said third extensible material has a predominant coloration that is visually distinct from said predominant coloration of said first extensible material and that is visually distinct from said predominant coloration of said second extensible material.

13. The color change laminate material of claim 8 wherein at least one of said first, second, and third extensible materials is an elastic material.

14. The color change laminate material of claim 12 wherein at least one of said first, second, and third extensible materials is an elastic material.

15. A personal care product comprising the color change laminate material of claim 1.

16. A personal care product comprising the color change laminate material of claim 8.

17. A personal care product comprising the color change laminate material of claim 13.

18. A protective wear product comprising the color change laminate material of claim 1.

19. A stretch tab material comprising the color change laminate material of claim 5.

20. An elastic bandage comprising the color change laminate material of claim 14.
